(19) United States
(12) Patent Application Publication
(10) Pub. No.: US 2010/0332426 A1
(43) Pub. Date: Dec. 30, 2010

(54) METHOD OF IDENTIFYING LIKE-MINDED USERS ACCESSING THE INTERNET

(75) Inventor: Jeroen Van Bemmel, Leiden (NL)

Correspondence Address: FAY SHARPE/LUCENT, 1228 Euclid Avenue, 5th Floor, The Halle Building, Cleveland, OH, 44115-1843, US

(73) Assignee: Alcatel Lucent

(21) Appl. No.: 12/603,082

(22) Filed: Oct. 21, 2009

(30) Foreign Application Priority Data
Jun. 30, 2009 (EP) 09290507.4

(51) Int. Cl. G06F 15/18; G06F 15/16; G06F 3/14

(52) U.S. Cl. 706/12; 715/733

(57) ABSTRACT

A method of identifying like-minded users accessing the Internet, comprises presenting a multimedia item to a user on an Internet site visited by the user. The user is offered at least one mechanism to provide a response to the item. Responses to the item from a plurality of users are collected. Those people providing the same response to the item are identified as like-minded.

### FIELD OF THE INVENTION

The present invention relates to a method of identifying like-minded users accessing the Internet.

### BACKGROUND OF THE INVENTION

The Internet provides such vast amounts of continually changing data that it can be difficult to navigate to find those parts that are of particular interest, even with well developed searching techniques. It can be even more problematic to establish connections with other people via the Internet. It is difficult to identify those who may share similar values and outlook to oneself, and hence have greater potential of becoming a friend. One approach to finding people with whom a user may share a like-minded outlook is to check social websites or communities for people that list interests that align with those of the user. However, identifying potential friends among the large numbers that access the Internet remains challenging.

### BRIEF SUMMARY

According to the invention, a method of identifying like-minded users accessing the Internet comprises presenting a multimedia item to a user on an Internet site visited by the user. The user is offered at least one mechanism to provide a response to the item. Responses to the item from a plurality of users are collected. Those people providing the same response to the item are identified as like-minded.

In one embodiment, a multimedia item may be played or displayed for a large audience of users, and responses to it collected from that audience. Groups of people with similar responses are then matched using a matching algorithm. People having closely matching responses, demonstrating like-mindedness, may be put into contact each other. This facilitates people having a potential to become friends connecting with one another.

The multimedia item may be one of the following, non-exhaustive list of possibilities: text fragment, music track, audio fragment, movie trailer, video clip, news item, image, personal information such as favorite places, animals, arts, sports, colors, food, areas of study, political leanings, books, TV habits, favourite web sites, theatre, volunteer or community work, hobbies, and so on. The mechanism to provide a response may be, for example, a ‘yes’ or ‘no’ button, to indicate if a user approves or not of the presented item, a text box allowing an individual response, multiple choice, or some other mechanism. It is only necessary that it permits a user to register his or her response to the item or items presented to them.

Responses are collected over time. A larger audience of users is more likely to generate matches and require less time to obtain useful matching information.

A user may visit a dedicated web page to take part in the scheme. Alternatively, or additionally, a user may be invited to respond when going to a search page, or to do something else, such as order a download from a music store, log on to a site, view a map, or a news page, or reviews of various media, for example.

### BRIEF DESCRIPTION OF THE DRAWING

Some embodiments of the present invention are now described by way of example only, and with reference to the accompanying drawing, in which:

FIG. 1 schematically illustrates steps of a method in accordance with the invention.

### DETAILED DESCRIPTION

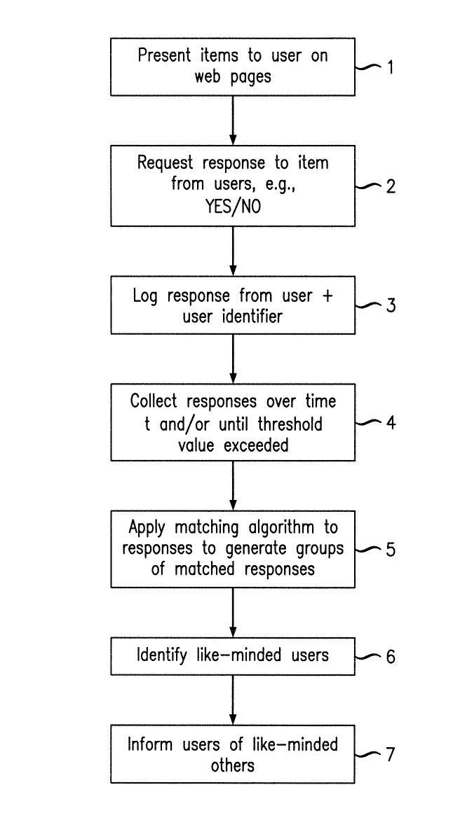

With reference to FIG. 1, in one method in accordance with the invention, at step 1, a web page on the public Internet is accessible to potentially a significant number of users. An item, or selection of items, is presented via the web page to a user calling up the web page. The item may be, for example, a text phrase such as, for example, a poem or a political statement, or a video clip, an audio clip, music, an image, or some other item of a multimedia nature. Combinations or sequences of such items might be presented to the user for their consideration.

At step 2, which may occur, for example, simultaneously with or subsequent to step 1, a mechanism is provided to the user to enable them to record a response to the item presented to them. For example, the user may offered voting buttons (“OK”/“not OK”), multiple choice answers, a dialog box for arbitrary text (single words or short phrases), speech-response capability, or some other form of mechanism for registering a response. The response may be a single operation or a combination of operations by the user. The response of the user and some form of identifying information to associate the user with their response is logged at step 3.

At step 4, responses to the item, or items, presented to users are collected over a given period of time t and then a matching algorithm is executed at step 5. Alternatively, or in addition, the matching algorithm of step 5 is executed when the number of responses exceeds a threshold value.

The matching algorithm operates to group together users providing the same or similar responses to the items with which they were presented. For example, where users are invited to select ‘yes’ or ‘no’ buttons, the population is divided into two groups: those who answered ‘yes’, and those who answered ‘no’. Groupings based on more complex input data may be obtained by, for example, permitting responses with more potential variation, or responses by a user that relate to linked item. For example, a specific response to a first item may result in a particular second item being presented in preference to another item that would have been presented next if the initial response had been different.

Steps 1 to 5 are repeated several times to obtain additional information by presenting different items, registering user responses and applying the matching algorithm to the fresh data.

At step 6, those people repeatedly ending up in the same groups as particular other users are identified, and are then informed at step 7 of their like-mindedness, for example, by displaying to each user the names of people found to be giving similar responses to him or her, or informing them in some other manner.

In another method in accordance with the invention, responses to stimuli are gathered from a plurality of web pages and then used in combination to group users.

The item to which a user is invited to respond may alternatively, or in addition, be presented to a user as part of another process, for example, during an existing login procedure to a web site.

Other algorithms may be used to match people. For example, an algorithm may be based on similarity of text responses (for example, case-insensitive string equality). Also, more complex algorithms are possible, such as those involving artificial intelligence techniques to build a model based on a training strategy. For example, an algorithm may be trained by observing groups of friends and their responses to various items presented to them. This enables dynamic learning of patterns of responses that correspond to a high likelihood of particular users becoming friends.

The resulting data indicating that users have similar outlooks may be used in various ways. For example, the users in a group may be automatically placed on an e-mail distribution list. Or they may be automatically linked on a social networking site of their choice. The group may also be temporary, displaying a dynamic list of matching users that is updated as more responses are collected.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A method of identifying like-minded users accessing the Internet, comprising:
presenting a multimedia item to a user on an Internet site visited by the user;
offering at least one mechanism for the user to provide a response to said item;
collecting responses to said item from a plurality of users; and
identifying as like-minded people those providing the same response to said item.

2. The method as claimed in claim 1 and including applying a matching algorithm to collected responses to said item from a plurality of users to group together users providing the same response.

3. The method as claimed in claim 2 and, prior to applying the matching algorithm, collecting responses for at least one of: a predetermined time; and until the number of responses exceeds a threshold value.

4. The method as claimed in claim 2 and wherein the matching algorithm is trained to develop its model.

5. The method as claimed in claim 1 and wherein a plurality of different items are presented to users for users to provide responses thereto.

6. The method as claimed in claim 1 and wherein a user is informed of the identities

7. The method as claimed in claim 1 and wherein the item is at least one of a: text fragment, music track, audio fragment, movie trailer, video clip, and image.

8. The method as claimed in claim 1 and wherein the mechanism to provide response is at least one of: ‘yes’/‘no’ button; a text box; and multiple choice selection.

9. The method as claimed in claim 1 and wherein the item is presented on a web page dedicated to that purpose.

10. The method as claimed in claim 1 wherein the item is presented on a web page that fulfils an additional purpose.
